(19) United States
(12) Patent Application Publication
(10) Pub. No.: US 2009/0210283 A1
(43) Pub. Date: Aug. 20, 2009

(54) SUPPORT MANAGEMENT METHOD, SUPPORT MANAGEMENT SYSTEM AND INFORMATION PROCESSING DEVICE

(75) Inventor: Takashi MIYAMOTO, Takamatsu (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kanagawa (JP)

(21) Appl. No.: 12/413,273

(22) Filed: Mar. 27, 2009

Related U.S. Application Data
(63) Continuation-in-part of application No. 12/237,937, filed on Sep. 25, 2008.

(30) Foreign Application Priority Data
Sep. 28, 2007 (JP) 2007-256108
Sep. 24, 2008 (JP) 2008-244817

(51) Int. Cl. G06Q 10/00; G06F 11/07

(52) U.S. Cl. 705/9; 714/57; 714/E11.024

(57) ABSTRACT

A trouble-shooting measure against a fault in an external device installed at a remote place is supported by receiving fault information on the fault that has occurred in the external device, acquiring an installation place of the external device in which the fault has occurred, a repair procedure acquisition unit for acquiring a repair procedure representing a list of candidates of qualified maintenance persons and an outline of the fault that can be dealt with by the maintenance persons included in the list, acquiring a job situation of the maintenance person, and transmitting a trouble-shooting instruction against the fault to a communication terminal unit of a qualified maintenance person in accordance with the acquired repair procedure. Further, trouble-shooting instruction is transmitted in priority to an optimum maintenance person selected based on a relation between the acquired repair procedure and the job situation.

### CROSS REFERENCE TO RELATED APPLICATIONS

This application is a continuation-in-part application, which claims the benefit of pending U.S. patent application Ser. No. 12/237,937 filed Sep. 25, 2008, which claims priority under 35 U.S.C. § 119(a) on Patent Applications No. 2007-256108 in Japan on Sep. 28, 2007. Further, this continuation-in-part application claims priority under 35 U.S.C. § 119(a) on Patent Applications No. 2008-244817 in Japan on Sep. 24, 2008. The disclosure of all the prior applications is hereby incorporated in its entirety by reference.

### BACKGROUND

The present invention relates to a trouble-shooting measure support management method capable of transmitting, in case of a fault in an external device, a trouble-shooting instruction and a priority notification to a communication terminal unit of an optimum maintenance person determined from the relation between the contents of the fault and the job situation of the maintenance person, a support management system for realizing the method and an information processing device included in the system.

In recent years, the information processing systems such as the automatic cash transaction system, the automatic ticket selling system and other server/client systems have come to constitute the lifelines indispensable for various industries and the daily life. In view of this, various countermeasures are desirably conceived and taken quickly against a fault which may occur in the information processing systems.

A method has been employed, for example, to notify a fault, if detected in an information processing system, to a manager, who selects an optimum maintenance person taking the specifics of the fault and the skill and the level of the task of the maintenance person into consideration, and gives an instruction to the maintenance person thus selected. This method, however, poses the problem of personnel resources due to the fact that the manager is required to work around the clock to keep up with the ever-changing situation, and have the human skill to accurately select an optimum maintenance person without any decision error or delay and to issue an instruction quickly to the selected maintenance person.

In view of this, a conventional support management method using an information processing device such as a server in place of the manager has been proposed in which the particular information processing device notifies the communication terminal unit of the maintenance person in accordance with the notification procedure corresponding to the contents of the fault (described, for example, in Japanese Patent Application Laid-Open No. 2002-33731). The method described in Japanese Patent Application Laid-Open No. 2002-33731 has made it possible to accurately select a maintenance person and give an instruction quickly to the maintenance person without resorting to the skill of the manager. In the method described in the Japanese Patent Application Laid-Open No. 2002-33731, however, the maintenance person is simply notified in accordance with the preset notification procedure without taking into consideration the current job situation of the maintenance person such as whether the maintenance person to be notified is off duty or in vacation and cannot be contacted, whether the maintenance person to be contacted is not a full-time worker and not well up to the local geography or whether the maintenance person contacted is not in a position to take a trouble-shooting measure immediately, thereby posing the problem that the maintenance person cannot be positively contacted.

### SUMMARY

According to an aspect of an embodiment, there is provided a support management method, whereat fault information on a fault occurring in an external device installed at a remote place is received by a management device supporting the trouble-shooting measure, the procedure for notifying the maintenance person is acquired based on the fault information received and a trouble-shooting instruction against the fault is transmitted to a communication terminal unit of the maintenance person to be contacted in accordance with the acquired notification procedure, and wherein the management device acquires the job situation of plural maintenance persons, selects an optimum maintenance person based on the relation between the acquired notification procedure and the job situation and gives a notification in priority to the communication terminal unit of the selected maintenance person according to the notification procedure.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a diagram showing a general configuration of a support management system according to the invention;

FIG. 2 is a block diagram showing a configuration of a management device;

FIG. 3 is a diagram for explaining an example of storage in a fault information table;

FIG. 4 is a diagram for explaining an example of storage in a trouble-shooting measure list table;

FIG. 5 is a diagram for explaining an example of storage in a notification procedure list table;

FIG. 6 is a diagram for explaining an example of storage in a maintenance person information table;

FIG. 7 is a diagram for explaining an example of storage in a device information table;

FIG. 8 is a diagram for explaining an example of storage in an installation facility information table;

FIG. 9 is a diagram for explaining an example of a data structure of an entry/exit permission management data;

FIG. 10 is a flowchart showing the steps of a trouble-shooting support management process executed by the management device;

FIG. 11 is a flowchart showing the steps of the trouble-shooting support management process executed by the management device;

FIG. 12 is a flowchart showing the steps of a trouble-shooting measure analysis process;

FIG. 13 is a flowchart showing the steps of a maintenance person information acquisition process;

FIG. 14 is a flowchart showing the steps of a contact address determining process;

FIG. 15 is a flowchart showing the steps of a remote trouble-shooting process;

FIG. 16 is a flowchart showing the steps of a local trouble-shooting process;

FIG. 17A and FIG. 17B are exemplary schematic diagrams representing entry/exit permission information to be displayed;

FIG. 18 is a flowchart representing procedure for entry/exit permission information generation processes;

FIG. 19 is a flowchart representing procedure for entry/exit permission information generation processes;

FIG. 20 is an exemplary schematic diagram representative of displaying map information;

FIG. 21 is a flowchart representing procedure for map information generation processes;

FIG. 22 is a flowchart representing procedure for authentication processes using entry/exit permission information; and

FIG. 23 is a flowchart representing procedure for maintenance person addition processes.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

### First Embodiment

Now, a support management system, a management device and a support management method according to the invention will be explained with reference to the drawings illustrating embodiments.

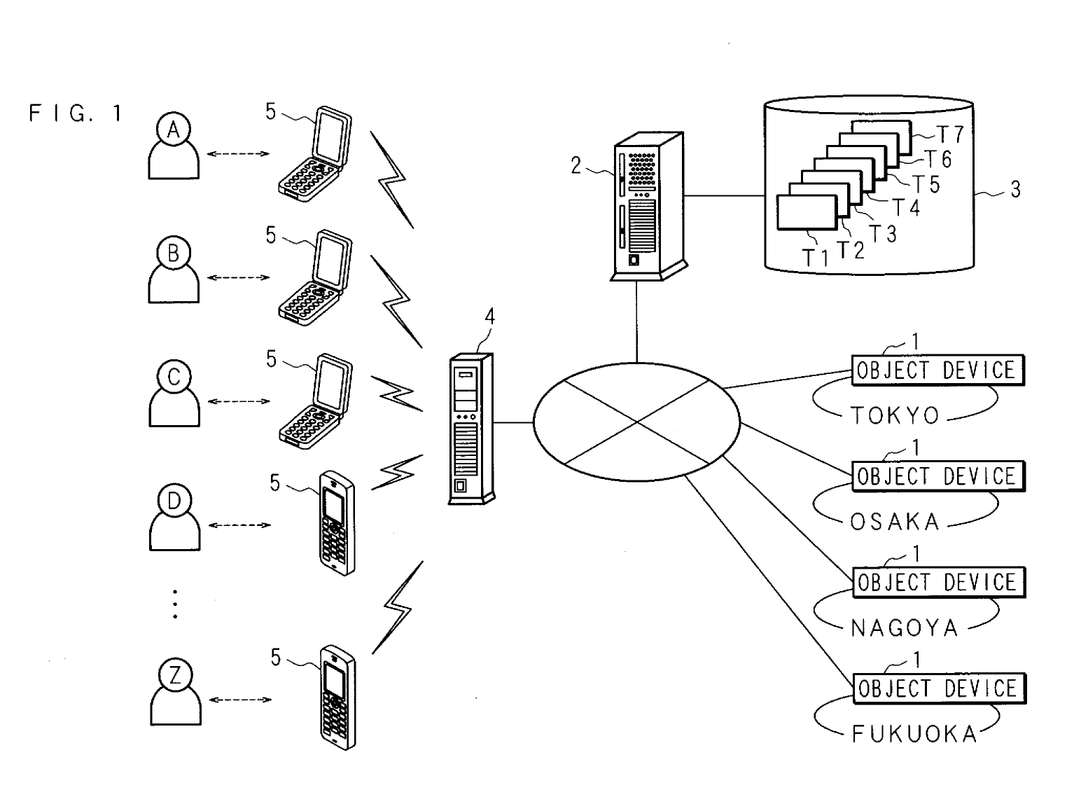

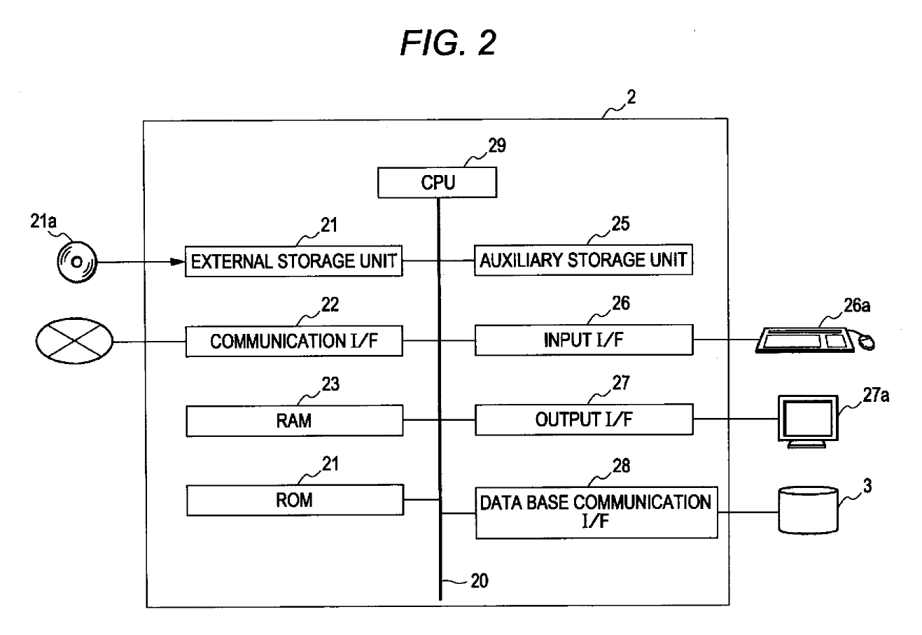

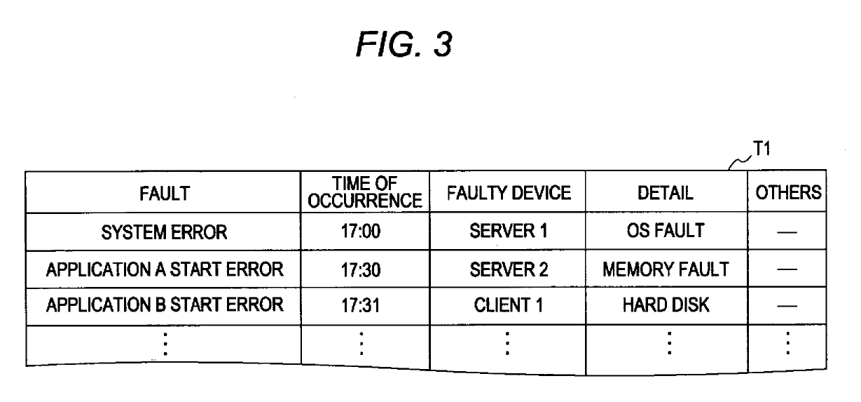

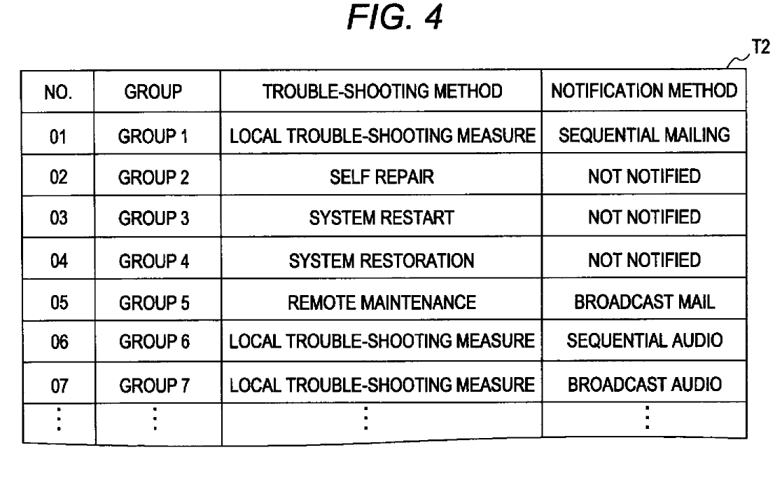

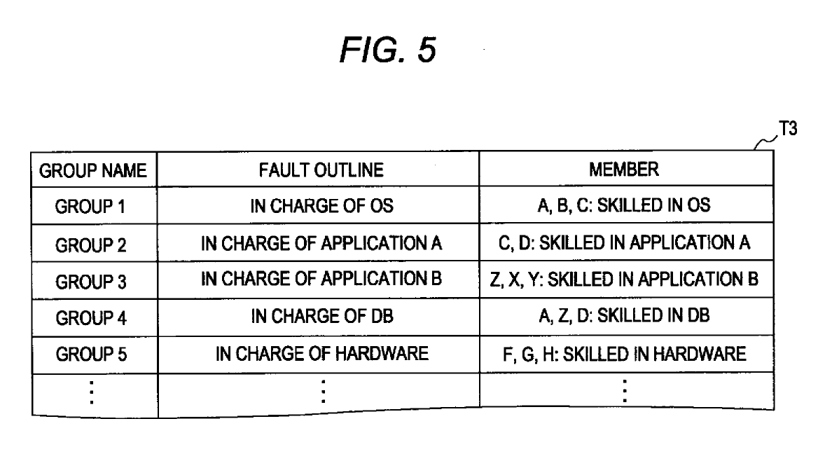

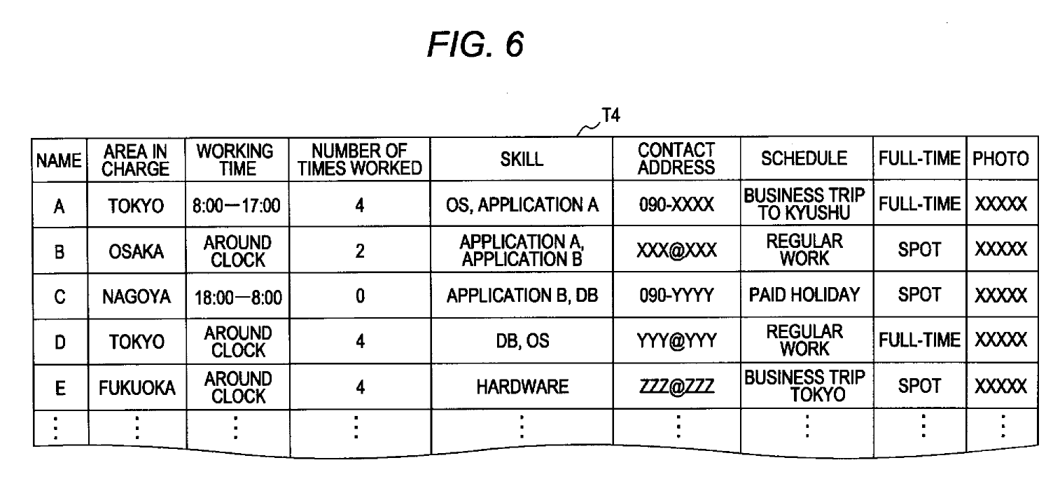

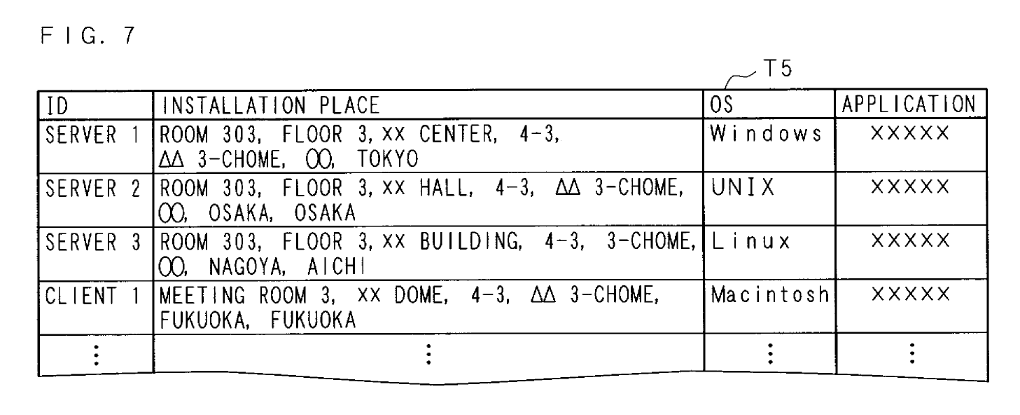

FIG. 1 is a diagram illustrating a general configuration of the support management system according to an embodiment, FIG. 2 a block diagram illustrating the configuration of the management device according to this embodiment, FIG. 3 a diagram for explaining an example of storage in a fault information table according to this embodiment, FIG. 4 a diagram for explaining an example of storage in a trouble-shooting measure list table according to this embodiment, FIG. 5 a diagram for explaining an example of storage in a notification procedure list table according to this embodiment, FIG. 6 a diagram for explaining an example of storage in a maintenance person information table according to this embodiment, and FIG. 7 a diagram for explaining an example of storage in a device information table according to this embodiment.

As illustrated in FIG. 1, the support management system includes a management device 2 for supporting the trouble-shooting measure, a data base 3 connected to the management device 2 and communication terminal units 5 to be contacted for contacting maintenance persons A to Z. Also, the support management system can communicate with object devices 1 outside the system and a web server 4 through a communication network. Each object device 1 is any external device which may be required to be repaired and has communication functions, such as (without limitation) a server PC, a client PC, a facsimile communication unit, an automatic cash transaction machine and an automatic ticket dispenser, etc. Multiple object devices 1 are installed at arbitrary places, for example, Tokyo, Osaka, Nagoya and Fukuoka.

Each object device 1 includes one or more of a fault detector (not shown) for detecting at least a fault occurring in itself, a fault analyzer (not shown) for analyzing a measure for the detected fault, a transmission controller (not shown) for transmitting the fault information indicating the detected fault, a remote operation controller (not shown) adapted for remote operation according to a command and a self-restoration controller for executing such process(s) as the system restart, the system restoration or the self repair according to a command.

In FIG. 2, the management device 2 is for managing the support management system as a whole, and executes the various processes including at least the analysis of the trouble-shooting measure to be taken against a fault, the acquisition of the notification procedure, the acquisition of the maintenance person information, the construction of the notification procedure, the determination of the contact address, the transmission of the trouble-shooting instruction, the confirmation of the response to the notification, the confirmation of the completion of the trouble-shooting measure, the decision as to a full-time worker or not, the provisional issue of the entry/exit permission, the provision of the map information to the fault site, the confirmation of the authentication success and the cancellation of the entry/exit permission.

Although this embodiment deals with an example in which the processes are executed with a single management device 2, plural management devices 2 may share the job of executing the processes.

The management device 2 includes an external storage unit 21, a communication interface 22, a RAM 23, a ROM 24, an auxiliary storage unit 25, an input interface 26, an output interface 27, a data base communication interface 28 and a CPU 29. These hardware units are interconnected through a bus 20. The external storage unit 21 is for reading a program and various data stored in a recording medium 21a. Upon insertion of the recording medium 21a into an insertion hole (not shown), the external storage unit 21 reads the program and the various data stored in the recording medium 21a inserted, and outputs the program, etc. thus read to the RAM 23. The recording medium 21a has stored therein the program and the various data used by the CPU 29 to execute the various processes concerning the trouble-shooting support management. The recording medium 21a is an optical disk such as a DVD (digital versatile disk) or a CD (compact disk), a magnetic disk such as a flexible disk or a hard disk, a semiconductor disk such as an IC card, a semiconductor memory such as a mask ROM, an EPROM, an EEPROM or a flash ROM, or a magnetic tape.

The communication interface 22 is a terminal unit of the communication network and provides a window for communication with external devices such as the object devices 1, the web server 4 and the communication terminal units 5 through the communication network. The communication network is, for example, the internet, the intranet, the extranet, the LAN, the ISDN circuit network, the VAN, the CATV communication network, the virtual private network, the telephone line network, the mobile communication network or the satellite communication network. The communication interface 22 receives the various data accepted from external sources and outputs the various data thus received to the RAM 23. Also, the communication interface 22 sends out various data or control commands to external devices.

The transmission media used in the communication interface 22 include not only wired ones such as the IEEE1334, the USB, the power line carrier, the CATV channel, the telephone line and the ADSL channel but also the wireless ones such as the infrared ray, the BLUETOOTH, the 802.11 radio, the HDR, the portable phone channel, the satellite channel and the terrestrial wave digital network.

The RAM 23 is a main storage unit adapted to store plural information and read them regardless of the order or position in which they are stored. The RAM 23 is classified into SRAM and DRAM. The RAM 23 stores, for example, the program read from the ROM 24, the various data generated by execution of the program and the various signals received from external sources. The RAM 23 reads the stored data as required in accordance with the read instruction from the CPU 29. The ROM 24 is a main storage unit capable of storing plural information and reading them in any order or from any storage position. The information stored in the ROM 24 is not erased even in the case where the power thereof is switched off or to a lower level. The ROM 24 is configured of, for example, a semiconductor element and classified into a mask ROM, a PROM and a flash memory. The ROM 24 stores, for example, the programs or the various data permitting the management device 2 to execute the various processes for the trouble-shooting support management. The ROM 24 reads, as required, the stored data in accordance with a read instruction from the CPU 29.

The auxiliary storage unit 25 is, for example, a hard disk of magnetic memory type. The auxiliary storage unit 25 stores the programs and the various data read from the recording medium 21a.

The input interface 26 is connected to an input unit 26a. The input unit 26a is, for example, a keyboard or a mouse and outputs various instruction signals in accordance with the user input. The input unit 26a is used to input an instruction on the trouble-shooting support management. The input interface 26 receives the various instruction signals output from the input unit 26a and outputs the various instruction signals thus received to the CPU 29.

The output interface 27 is connected to a display unit 27a. The display unit 27a is used to output the video information on the trouble-shooting support management. The output interface 27 outputs the various information to the display unit 27a.

The data base communication interface 28 is connected to the data base 3 and provides a window for communication with the data base 3.

The CPU 29 controls each hardware of the management device 2 on the one hand and executes the various processes on the trouble-shooting support management on the other hand. The procedure for the various processes on the trouble-shooting support management executed by the management device 2 will be explained later.

The data base 3 is a collection of the information arranged and managed systematically, and implemented by the storage unit such as the hard disk of magnetic storage type. The data base 3 has stored therein plural tables which are read as required in accordance with an instruction from the CPU 29 of the management device 2.

An explanation is given about an example of storage in a fault information table T1, a trouble-shooting measure list table T2, a notification procedure list table T3, a maintenance person information table T4, a device information table T5, an installation facility information table T6, and an entry/exit permission management data T7 stored in the data base 3.

Fault Information Table T1

The object device 1 at fault detects the fault in itself by the fault detector, and analyzes the measure for the detected fault by the fault analyzer. The object device 1 transmits the fault information concerning the detected fault to the management device 2. The management device 2 receives the transmitted fault information from the object device 1, and store the received fault information with sorting in terms of occurrence time points in the fault information table T1.

In FIG. 3, the fault information table T1 has stored therein the fault information on the faults that have occurred in each object device 1. The fault information stored in the fault information table T1 is held in correspondence with the contents of the fault, the time of fault occurrence, the object device in which the fault has occurred, the detail of the fault and other items. The fault information table T1 further stores code numbers for identifying the contents of the fault, software names at fault, situations at the time points of the fault occurrence, reasons of the fault, IP addresses of the object devices 1 at fault, MAC addresses of component parts at fault, trouble-shooting measures analyzed, operation time required for the measures, and the like.

Trouble-shooting measure list table T2

In FIG. 4, the trouble-shooting measure list table T2 has stored therein the information on the trouble-shooting measure against the fault, as classified according to the maintenance person group. The trouble-shooting measure information is held in correspondence with the maintenance person group to take charge of repairing the fault, the trouble-shooting method and the method of notification to each trouble-shooting maintenance person group. The trouble-shooting measure information is preset by the administrator.

The management device 2 instructs to the maintenance person that he/she takes care of the fault at the site of fault, for example, when the object device 1 analyzes the measure as “local measure.” The management device 2 instructs to the maintenance person that he/she operates the object device 1 in remote out of the site of fault, when the object device 1 analyzes the measure as “remote maintenance.” Operations using commands of the management device 2 allow the object device 1 to restart the operating system (hereinafter referred to as “the OS”) without any instruction to the maintenance person, when the object device 1 analyzes the measure as “system restart.” Operations using the commands of the management device 2 allow the object device 1 to restore the OS to the state before the fault, when the object device 1 analyzes the measure as “restoration of the system.” Operations using the commands of the management device 2 allow the object device 1 to self-repair data destroyed, when the object device 1 analyzes the measure as “self repair.”

Also, the management device 2 transmits electronic mails (e-mails) to the communication terminal units 5 of the maintenance persons sequentially, when the notification method corresponding to the measure analyzed by the object device 1 is “sequential mail.” The management device 2 transmits the e-mails to the terminals 5 of the maintenance persons at the same time, when the notification method corresponding to the measure analyzed by the object device 1 is “broadcast mail.” The management device 2 transmits audio information (e.g., voice mails) to the terminals 5 of the maintenance persons sequentially, when the notification method corresponding to the measure analyzed by the object device 1 is “sequential audio.” The management device 2 transmits the audio information (e.g., voice mails) to the maintenance persons at the same time, when the notification method corresponding to the measure analyzed by the object device 1 is “broadcast audio.” The management device 2 does not notify to the terminals 5, when the notification method corresponding to the measure analyzed by the object device 1 is “non-notification.”

Notification Procedure List Table T3

In FIG. 5, the notification procedure list table T3 has stored therein the repair procedure for notifying a maintenance person classified according to the group to which the maintenance person taking the trouble-shooting measure against the fault belongs. The repair procedure (herein also referred to as notification procedure) is held in correspondence with the name of the group to take a trouble-shooting measure, the outline of the fault that can be dealt with by each maintenance person group (i.e., fault handling capability or repair procedure), the names of or the skill owned by the members of each group. The repair procedure (notification procedure) is preset by the administrator. In the case where the fault outline (i.e., repair procedure) that can be dealt with is related to the fault that has occurred in the object device 1, the notification repair procedure for the maintenance person group in charge of the particular fault outline constitutes a candidate for the notification repair procedure. In the absence of the maintenance person group in charge of the outline of the fault that has occurred in the object device 1, however, the maintenance person group in charge of the fault outline analogous or approximate to the fault of the object device 1, for example, is selected as a candidate for the notification procedure. Also, according to an aspect of an embodiment, the names of the constituent members are stored in the order of notification of the trouble-shooting instruction, and this order can be used as the order of notification in the normal state. The management device 2 judges whether or not the content of the fault in the object device 1 relates any of the outlines in the notification procedure list table T3. When the judgment is affirmative, the management device 2 selects the notification procedure to the persons in the group being able to take charge of the fault corresponding to the related outline of the fault. Besides, when it is judged that the content of the fault of the objective device 1 does not relates any of the outlines in the notification procedure list T3, the management device 2 selects the notification procedure to the persons in the group being able to take charge of the fault similar to the fault that the object device 1 now suffers from. The management device 2 compares character strings of both the content of the fault and the outlines of the fault in the table T3 one by one for evaluating similarities between the content and the outlines. The management device 2 takes the outline in the greatest similarity among those as “related.”

The members of the selected group are listed in the table T3 and an upper listed member has more priority to be notified with the instruction for the measure according to the chosen notification procedure.

Maintenance Person Information Table T4

In FIG. 6, the maintenance person information table T4 has stored therein the maintenance person information on the job situation classified according to each maintenance person. The maintenance person information is held, in a non-limiting example, in correspondence with one or more of the names of the maintenance persons, the area taken charge of by the maintenance persons, the time worked by the maintenance persons, the number of times worked by the maintenance persons, the skill owned by the maintenance persons, the contact address of the maintenance persons, the schedule of the maintenance persons, the data indicating whether the maintenance persons are full-time workers or not, and photo data of the maintenance persons. The maintenance person information except both the number of times worked by the maintenance person and the schedule of the maintenance persons is preset by the administrator.

The management device 2 picks up the maintenance persons who take charge of the areas that locates just on the site of or close to the site of the installation location of the object device 1 at fault. The management device 2 selects the persons as optimum. The management device 2 judges whether or not distance from the installation location of the objective device 1 to the area for each person exceeds a predetermined value, and picks up the persons based on the judgment.

The management device 2 judges, for each maintenance person, whether or not the time point of occurrence of the fault is within duration of working of the person. Based on the judgments, the management device 2 picks up the persons who are accessible and can receive and confirm the instruction for trouble-shooting measure at the time point of the occurrence of the fault.

When plural maintenance persons have been picked up, the management device 2 further selects a maintenance person of most number of operation times as being optimum from among them. The management device 2 increments the number of operation times of the selected person every time he/she completes the measure for the fault.

The management device 2 judges whether or not the content of the fault occurred in the object device 1 corresponds to any of the skills of each maintenance person, which are stored in the maintenance person information table T4. When the judgment for each person is affirmative, the management device 2 picks up the person as being optimum for handling the measure. The management device 2 compares character strings of both the content of the fault and the skills of each person in the table T4 one by one for evaluating similarities between the content and the skills. The management device 2 takes the person who has the skill in the greatest similarity among those as being “optimum.”

The contact address of a maintenance person is that of the communication terminal unit 5 held privately by the particular maintenance person, which is, for example, the telephone number or the mail address of a mobile phone. The management device 2 transmits the various information to the communication terminal unit 5 indicated by the contact address.

Based on any of data which a external schedule management system manages, data obtained by polling to each communication terminal unit 5, data representing location which Global Positioning System (GPS) obtains, and the like, the management device 2 analyzes schedules of the maintenance persons, and store them in the maintenance person information table T4. The management device 2 picks up the persons whose schedules at the time point of the fault are “ordinary working hours” or the persons who are making business visit in the area close to the area of occurrence of the fault. The management device 2 judges such persons as being accessible. On the other hand, the management device 2 judges that contact to the persons whose schedules at the time point of the fault are “paid holiday” is impossible.

The management device 2 selects full-time maintenance persons prior to spot (part-time) maintenance persons as to the group of the measure, e.g., “the remote maintenance.” When the management device 2 selects any of the spot maintenance persons, the management device 2 transmits an entry/exit permission card on the site and map information for the site to such person.

Based on the combination of information of picking up and selecting from the trouble-shooting measure list table T2, the notification procedure list table T3 and the maintenance person information table T4, the management device 2 decides the maintenance person suitable for the measure to the fault formally. Procedure for the decision processes of the maintenance person will be explained below.

Device Information Table T5

In FIG. 7, the device information table T5 has stored therein the device information classified according to each of the object devices 1. The device information is held, in a non-limiting example, in correspondence with one or more of the ID for identifying each object device 1, the place of installation of each object device 1, the OS for controlling each object device 1 and the name of the application installed in each object device 1. The device information is preset by the administrator. The maintenance person working (as a maintenance person in charge or on business trip) in the neighborhood of the place of installation is selected as an optimum maintenance person. Also, the maintenance person holding the skill related to the OS or the application installed is selected as an optimum maintenance person. The notification procedure for the maintenance person group in charge of the OS or the application installed constitutes a candidate for the notification procedure (see FIG. 5).

The management device 2 extracts installation location corresponding to the identifier of the object device 1 at fault and names of the OS and the application of the object device 1 as device information from the device information table T5. The management device 2 decides the maintenance person based on such device information. The installation location of the object device 1 includes a room number and a floor number in the installation facility as well as an address including a name of the state, a name of the city, and the like where the installation facility locates.

Installation Facility Information Table T6

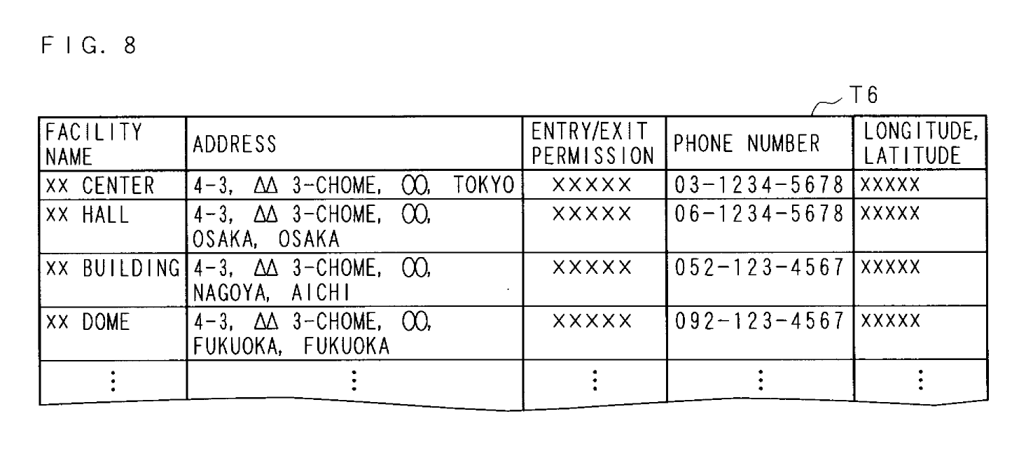

As shown in FIG. 8, the installation facility information table T6 stores installation facility information regarding the object devices 1. The installation facility information includes facility names, addresses of the facilities, original data of permission for entry/exit, phone numbers of the facilities, and longitudes and latitudes of the facilities which are associated with one another. The installation facility information is preset by the administrator.

The management device 2 generates the entry/exit permission information for entry/exit of the spot (part-time) maintenance persons into/from the facilities using the original data of permission for entry/exit. Procedure for the generation processes of the entry/exit permission information will be explained below.

The management device 2 generates the map information regarding the installation facilities using the longitudes and the latitudes, and the map information is given to the spot maintenance persons. Procedure for the generation processes of the map information will be explained below.

Entry/Exit Permission Management Data T7

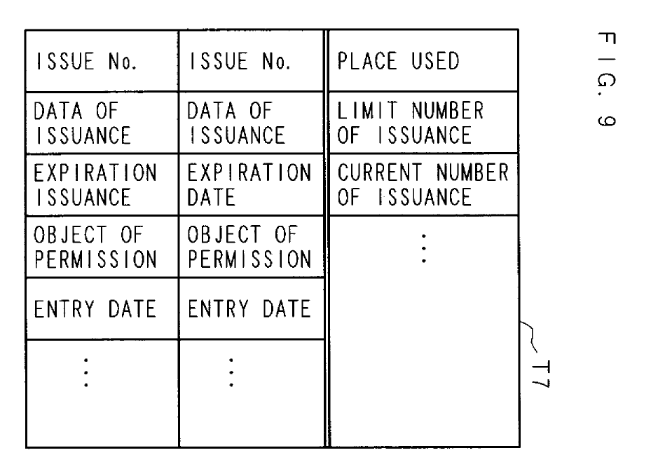

As shown in FIG. 9, the entry/exit permission management data T7 is for managing the entry/exit permission information and generated in association with the installation facilities. The entry/exit permission management data T7 includes a base region and an update region. In the base region, the installation locations where the entry/exit permission information is used, limit numbers of issuance of entry/exit permission for the installation locations, and current numbers of issuance of the entry/exit permission for the installation locations are stored. In the update region, issue numbers, issue dates, expiration dates (completion dates), objects of the permission, entry dates, and the like are stored and updated for each issuance of the entry/exit permission information.

The installation locations and the limit numbers of the issuance are preset by the administrator. The management device 2 increments the current number of the issuance for each issuance of the entry/exit permission information, and decrements the current number of the issuance for each deletion, which is caused by exit from the facility, of the issuance of the entry/exit permission information.

The web server 4 accumulates the information including the HTML document and the images, and in accordance with the request of the client software such as the web browser, functions to transmit these pieces of information through the communication network. The web server 4 functions to transmit not only the pull-type information such as the web site or the web mail but also the push-type information such as the electronic mail to each communication terminal unit 5.

Each communication terminal unit 5 is a communicable terminal unit privately owned or operated by each of the maintenance persons A to Z, such as a mobile phone, a PDA (personal digital assistant) with the communication function or a notebook-sized personal computer with the communication function. Also, each communication terminal unit 5 is set in correspondence with a maintenance person, so that the information to be notified to a predetermined maintenance person is transmitted to the corresponding communication terminal unit 5.

Each communication terminal unit 5 includes, in a non-limiting example, one or more of a communication controller for receiving the trouble-shooting instruction sent from the management device 2, a display unit for displaying the trouble-shooting instruction received, an input unit for receiving the input of a response signal, a remote operation unit for controlling a remote console, a command input unit supplied with a command on the remote operation, a command output unit for outputting the command, an input unit for inputting a completion signal indicating the completion of the trouble-shooting measure, a display unit for displaying the web browser, an input unit for inputting the job situation of the maintenance persons and a receiving unit for receiving the inquiry about the job situation of the maintenance persons.

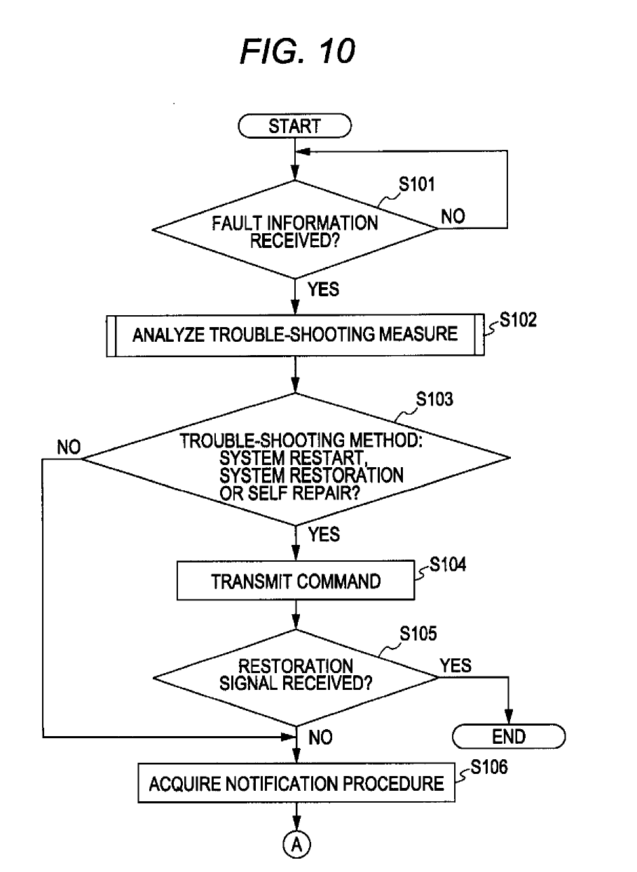

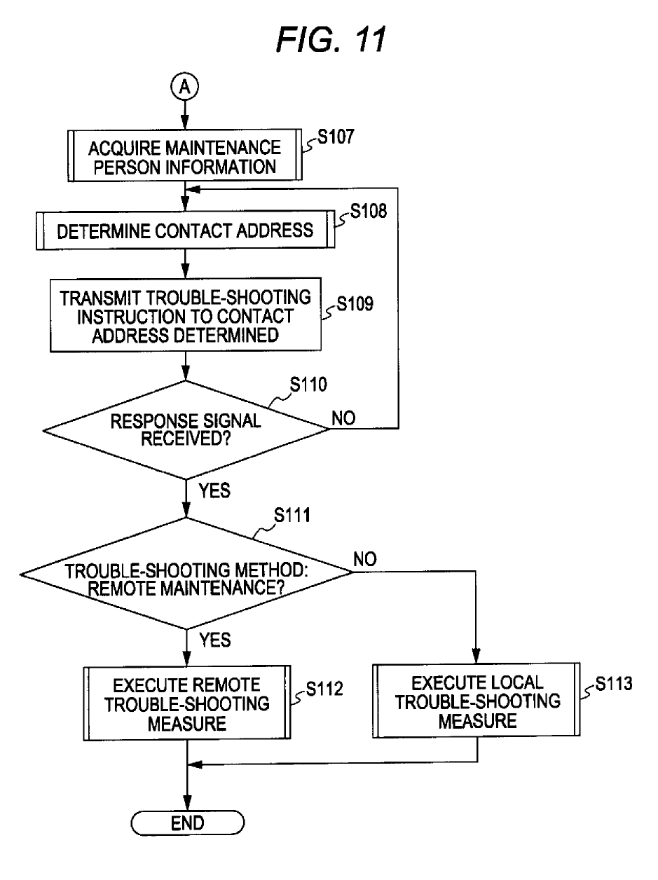

As described above, the support management system according to the embodiment includes the object device 1 which transmits the fault information and the management device 2 which receives the transmitted fault information. The management device 2 selects the maintenance person suitable for the fault according to predetermined rules, and transmits the instruction for the trouble-shooting measure preferentially to the communication terminal unit 5 of the selected maintenance person. Procedure for the processes which the management device 2 performs is explained hereinafter. FIG. 10 and FIG. 11 illustrate flowcharts of procedure for the trouble-shooting measure support management process performed by the management device 2.

Each object device 1 detects a fault in itself by the fault detector and analyzes trouble-shooting measure for the detected fault by the fault analyzer. The object device 1 transmits fault information concerning the fault to the management device 2. The CPU 29 of the management device 2 judges whether the fault information transmitted by each object device 1 has been received through the communication network or not (S101), and upon judgment that the fault information is not received (NO in step S101), determines that the object device 1 has not developed a fault, and repeats step S101 until the fault information is received. The CPU 29, on the other hand, executes the measure analysis process (S102) upon judgment that the fault information has been received (YES in step S101). The procedure for the trouble-shooting measure analysis process will be described later.

Also, the CPU 29 sequentially stores the received fault information in the fault information table T1. The CPU 29 judges whether the trouble-shooting method extracted in the trouble-shooting measure analysis process described later is associated with a non-notification or self troubleshooting type troubleshooting, for example, the system restart, the system restoration or the self repair (S103). In the case where the CPU 29 judges that the trouble-shooting method is not associated with the system restart, the system restoration or the self repair (NO in S103), the control proceeds to step S106 to acquire the notification procedure. In the case where the CPU 29 judges that the trouble-shooting method is associated with the system restart, the system restoration or the self repair (YES in S103), on the other hand, the command for activating these operation is transmitted to the object device 1 (S104).

Then, the object device 1 restarts the system, restores the system or repairs the fault by itself, as the case may be, in accordance with the received command, and upon restoration of the normal state, transmits the restoration signal. Incidentally, the process of carrying out the system restart, the system restoration or the self repair in accordance with the command uses the conventional technique, and therefore, the procedure thereof is not explained.

The CPU 29 judges whether the restoration signal transmitted from the object device 1 is received or not (S105), and upon judgment that the restoration signal is received (YES in step S105), judges that the fault of each object device 1 is repaired and finishes the trouble-shooting measure support management process. The CPU 29, upon judgment that the restoration signal is not received (NO in S105), on the other hand, acquires the notification procedure (S106). Specifically, the CPU 29 extracts, from the notification procedure list table T3, the members engaged in the job outline related to the contents of the fault extracted in the trouble-shooting measure analysis process. Then, the order in which the extracted members are arranged is acquired as the notification procedure.

The CPU 29 further executes the maintenance person information acquisition process (S107). The procedure for the maintenance person information acquisition process will be explained later. The CPU 29 further executes the contact address determining process based on the notification procedure and the maintenance person information acquired (S108). Incidentally, the procedure for the contact address determining process will be explained later. The CPU 29 transmits a trouble-shooting instruction to the contact address determined by the contact address determining process (S109). Specifically, the CPU 29 extracts, from the maintenance person information table T4, the contact address of the required maintenance person determined in the contact address determining process. Then, the trouble-shooting instruction is transmitted to the communication terminal unit 5 indicated by the extracted contact address.

The communication terminal unit 5 indicated by the extracted contact address receives, through the web server 4, the trouble-shooting instruction transmitted from the management device 2. The communication terminal unit 5 displays the received trouble-shooting instruction on the display unit (not shown). The communication terminal unit 5 receives, through the input unit (not shown), the input by the maintenance person as a response signal to the trouble-shooting instruction. The communication terminal unit 5 transmits the response signal. Incidentally, the communication terminal unit 5 not only receives the trouble-shooting instruction and displays it on the screen with the web browser, but also may receive the trouble-shooting instruction by an electronic mail or output with a voice indicating the trouble-shooting instruction.

The CPU 29 judges whether the response signal transmitted from the communication terminal unit 5 is received or not (S110), and upon judgment that the response signal is not received (NO in S110), judges that the notification to the determined contact address is impossible and returns the control to step S108 to execute the contact address determining process again based on the notification procedure for other than the particular contact address. As a result, the trouble-shooting instruction can be positively notified to any one of the maintenance persons.

The CPU 29, upon judgment that the response signal is received (YES in S110), on the other hand, judges whether the trouble-shooting method extracted in the trouble-shooting measure analysis process of step S102 corresponds to the remote maintenance or not (S111). Upon judgment that the trouble-shooting method corresponds to the remote maintenance (YES in S111), the CPU 29 executes the remote trouble-shooting process (S112) and thereby completes the trouble-shooting support management process. Incidentally, the procedure for the remote trouble-shooting process will be described later. Upon judgment that the trouble-shooting method does not correspond to the remote maintenance (NO in S111), on the other hand, the CPU 29 executes the local (on-site) trouble-shooting process (S113) and completes the trouble-shooting support management process. Incidentally, the procedure for the local trouble-shooting process will be explained later.

As described above, according to the invention, the trouble-shooting measure against a fault that has occurred in an external device installed at a remote place can be accurately and quickly supported without resorting to the human skill of the manager on the one hand and taking the job situation of the maintenance person into consideration on the other hand.

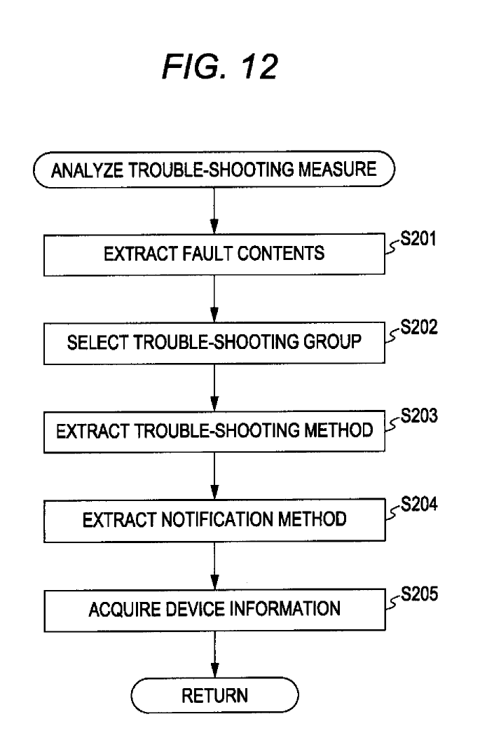

Next, the procedure for the trouble-shooting measure analysis process executed in step S102 by the management device 2 will be explained. FIG. 12 is a flowchart showing the procedure for the trouble-shooting measure analysis process. The CPU 29 of the management device 2 extracts the contents of the fault included in the fault information stored in the fault information table T1 (S201). Also, the CPU 29 extracts the outline of the extracted contents of the fault from the notification procedure list table T3, and selects the trouble-shooting maintenance person group corresponding to the extracted fault outline from the notification procedure list table T3 (S202). Further, the CPU 29 extracts the trouble-shooting method corresponding to the selected maintenance person group from the trouble-shooting measure list table T2 (S203). Also, the CPU 29 extracts the notification method corresponding to the extracted trouble-shooting method from the trouble-shooting measure list table T2 (S204). Furthermore, the CPU 29 extracts the object of the fault included in the fault information stored in the fault information table T1 and acquires the device information corresponding to the extracted object from the device information table T5 (S205). The CPU 29 stands by until the next process is restarted.

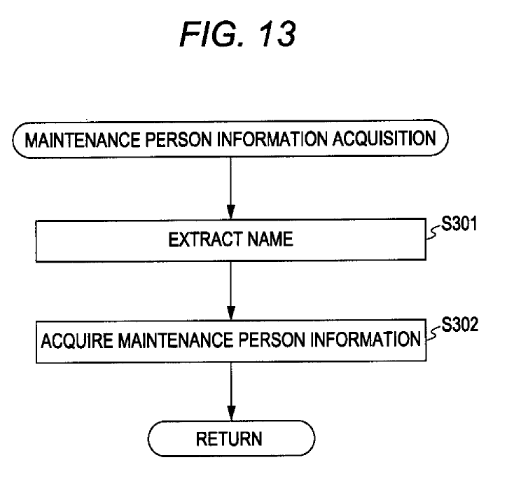

Next, the procedure for the maintenance person information acquisition process executed in step S107 by the management device 2 will be explained. FIG. 13 is a flowchart showing the procedure for the maintenance person information acquisition process. The CPU 29 of the management device 2 extracts, from the notification procedure list table T3, the name of each maintenance person included in the members making up the group selected in step S202 (S301). Also, the CPU 29 acquires the maintenance person information corresponding to the extracted name of each maintenance person from the maintenance person information table T4 (S302). The CPU 29 stands by until the next process is restarted.

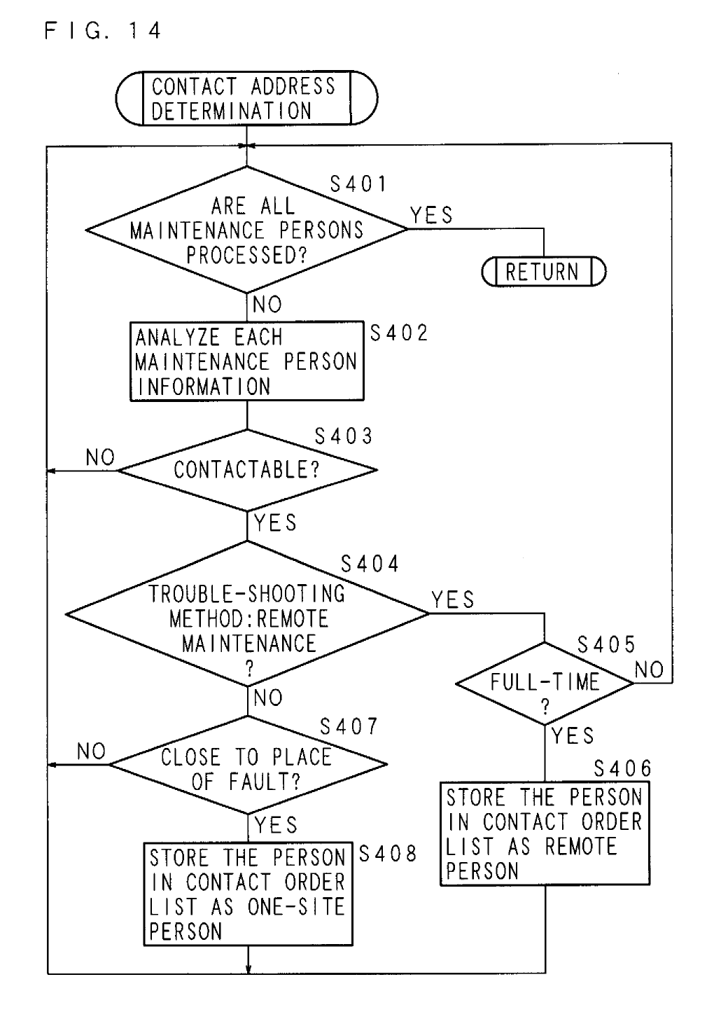

Next, the procedure for the contact address assembling process executed in step S108 by the management device 2 will be explained. FIG. 14 is a flowchart showing the procedure for the contact address determining process. The CPU 29 of the management device 2 judges whether the process has been applied to all the maintenance persons who are the members of the group which is chosen in step S202 (S401). When the judgment is affirmative (YES in S401), the CPU stands by until a next request for performing. When the CPU judges that the process has not been applied to any of the maintenance persons (NO in S401), the CPU 29 of the management device 2 analyzes the information on each maintenance person included in the maintenance person information acquired in step S302 (S402). The CPU 29 judges whether the maintenance person can be contacted or not, based on the on-duty hours or the schedule (S403), and upon judgment that the maintenance person cannot be contacted (NO in S403), returns the control to step S401 to analyze the information on a maintenance person constituting the next candidate. Then, the process is repeated.

The maintenance person cannot be contacted in the case where the maintenance person is off duty or in the vacation such as the paid holiday or in the case where the portable terminal unit 5 fails to respond. Incidentally, the portable terminal unit 5 fails to respond, for example, in the case where the command such as the Ping command to confirm the communicability is not answered. The maintenance person cannot be contacted not only in these cases, but also in the case where the positional information cannot be acquired from the portable terminal unit 5. The CPU 29, upon judgment that the maintenance person can be contacted (YES in S403), judges whether the candidate persons are the full-time maintenance persons based on the affirmative or negative of the full-time maintenance person thus extracted (S405). The CPU 29, upon judgment that the candidate person is not the full-time maintenance person (NO in S405), returns the operation to step S401. The CPU 29, upon judgment that the process has not been applied to any of the maintenance persons (again, NO in S401), analyzes the maintenance person information of the maintenance person who is the next candidate (again, S402).

The CPU 29, on the other hand, upon judgment that the candidate person is the full-time maintenance person (YES in S405), stores in the contact order list the candidate person as the remote maintenance person (S406). Thus, the CPU 29 returns the operation to step S401 and judges whether the process has been applied to all the maintenance persons (again, S401).

The CPU 29, upon judgment in step S404 that the trouble-shooting method is not the remote maintenance (NO in S404), judges whether the maintenance person is present in the neighborhood of the place of fault (the position where the faulty device 1 is installed) based on the area in his/her charge or his/her schedule (S407). The CPU 29, upon judgment that the maintenance person is absent in the neighborhood of the place of fault (NO in S407), returns the control to step S401, and repeats the process. The CPU 29 judges whether the maintenance person is not close to the area of the occurrence of the fault means that distance from the area in his/her charge or of business visit to the area of the occurrence of the fault exceeds the predetermined value, or that the maintenance person is in other municipality (again, S407).

The CPU 29, on the other hand, upon judgment that the maintenance person is close to the area of the occurrence of the fault (YES in S407), stores in the contact order list the candidate person as the maintenance person on the site (S408). The CPU 29 returns control to step S401, and judges whether the process has been applied to all the maintenance persons (again, S401).

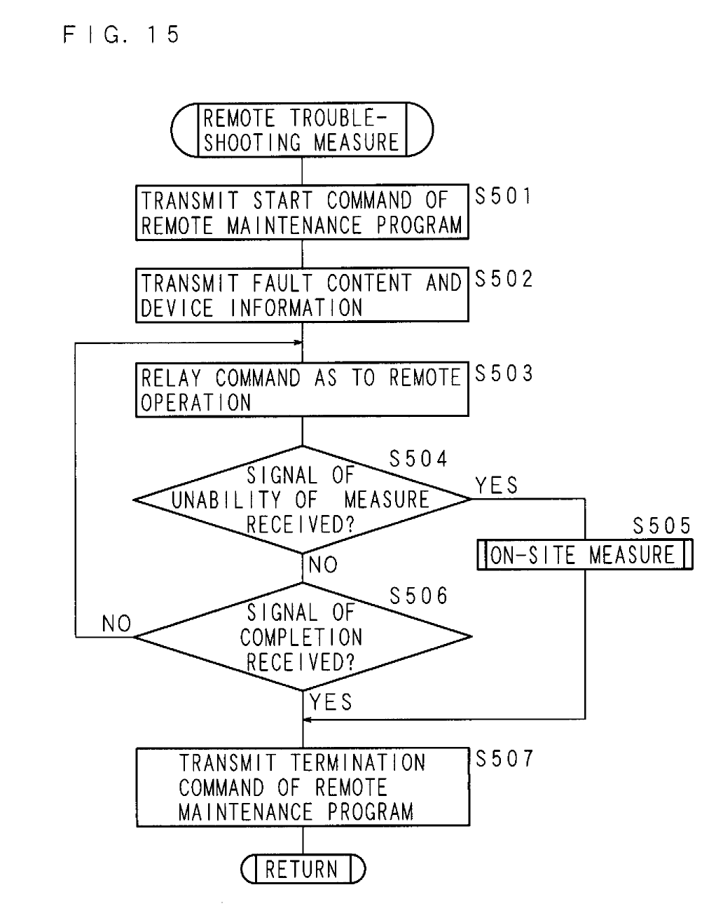

Next, the procedure for the remote trouble-shooting measure process which the CPU 29 performs in step S112 is explained. FIG. 15 is a flowchart illustrating the procedure for the remote measure process.

The CPU 29 of the management device 2 transmits the initiation command of the remote maintenance program to the communication terminal unit 5 of the maintenance person (S501). Further, the CPU 29 transmits the content of the fault and the device information (S502). The communication terminal unit 5 initiates the remote maintenance program in accordance with the initiation command. The communication terminal unit 5 accepts the command regarding the remote operation inputted by the maintenance person. The communication terminal unit 5 outputs the content of the fault and the device information on the display unit. The communication terminal unit 5 initiates the analysis program for analyzing the content of the fault and the device information. The communication terminal unit 5 accepts the command regarding the remote operation inputted from the maintenance person, and transmits the command regarding the accepted remote operation to the object device 1 via the management device 2.

The CPU 29 relays the command on the remote maintenance between the communication terminal unit 5 and the faulty device 1 that has developed the fault (S503). Incidentally, the command relay is the conventional technique and not explained.

The CPU 29 of the management device 2 judges whether or not the measure inability signal transmitted from the terminal 5 within the predetermined time period (S504). When the judgment is affirmative (YES in S504), the CPU 29 terminates the remote trouble-shooting measure process and performs the on-site trouble-shooting measure process (S505). Thus, the measure in remote is switched to the measure on site.

The CPU 29, on the other hand, upon judgment that the measure inability signal is not received with in the predetermined time period (NO in S504), judges whether or not the completion signal transmitted from the communication terminal unit 5 is received (S506). The maintenance person repairs the object device 1 at fault and inputs the completion of the repair into the terminal 5. The terminal 5, upon accepting the completion signal inputted by the maintenance person, transmits the accepted completion signal to the management device 2. Procedure for the accepting process of the completion signal in the terminal 5 will be explained below in detail. The CPU 29, upon judgment that the completion signal is not received (No in S506), returns the control to step S503 and continues to relay the command regarding the remote operation.

The CPU 29, on the other hand, upon judgment that the completion signal is received (Yes in S506), transmits the termination command of the remote maintenance program to the communication terminal unit 5 of the maintenance person (S507). The CPU 29 stands by until next request for the performing.

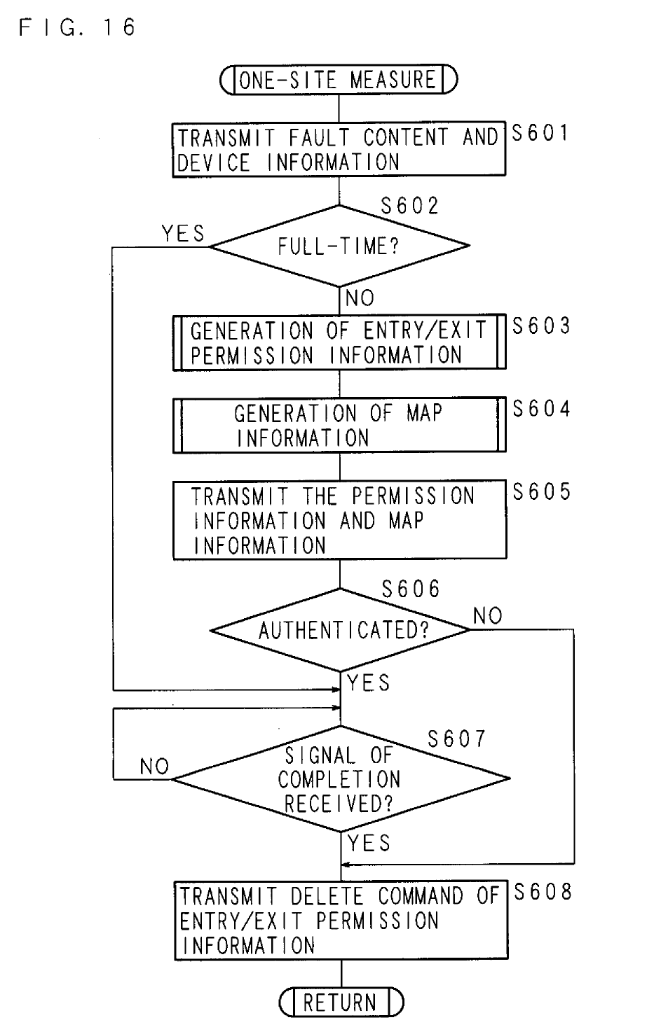

Next, the procedure for the local (on-site) trouble-shooting process executed in step S113 by the management device 2 will be explained. FIG. 16 is a flowchart showing the procedure for the local (on-site) trouble-shooting process. The contents of the fault extracted in step S201 and the device information acquired in step S205 are transmitted by the CPU 29 of the management device 2 to the communication terminal unit 5 constituting the destination of the response signal received in step S110 (S601).

The CPU 29, upon judgment whether the maintenance person is a full-time worker in charge of the trouble-shooting measure against the faulty device 1 (YES in S602), proceeds the control to step S607. The maintenance person inputs a completion signal indicating completion of repair of the object device 1 at fault. The communication terminal unit 5 transmits the accepted completion signal to the management device 2 when the terminal 5 accepts the inputted completion signal.

The CPU 29, on the other hand, upon judgment that the maintenance person is not the full-time worker (NO in S602), performs a generation process for generating entry/exit permission information for being used in entry/exit of a spot (part-time) maintenance person into/from the installation facility (S603). Procedure for entry/exit permission information generation processes will be explained below.

The CPU performs a generation process for generating map information concerning the installation facility for affording to the spot maintenance person who is an alien around the installation facility (S604). Procedure for map information generation processes will be explained below.

The CPU 29 transmits the entry/exit permission information and the map information thus generated to the terminal 5 of the spot maintenance person (S605). The terminal 5 receives the entry/exit permission information and the map information thus transmitted from the management device 2. The terminal 5 outputs the entry/exit permission information and the map information thus received to the displaying part. The spot maintenance person holding the terminal 5 visits the installation facility of the object device 1 at fault, referring to the outputted map information, and performs authentication processes using the entry/exit permission information.

The CPU 29 of the management device 2 judges whether the authentication process using the entry/exit permission information is successful or fails (S606). The CPU 29, upon judgment that the authentication process fails (NO in S606), performs a process of step S608. Procedure for the authentication processes will be explained below.

The CPU 29, on the other hand, upon judgment that the authentication process is successful (YES in S606), performs a process of step S607. After the maintenance person repairs the object device 1 at fault, the maintenance person inputs a completion signal of the repair into the communication terminal unit 5. The communication terminal unit 5, upon accepting the completion signal thus inputted, transmits the received completion signal to the management device 2.

Further explaining the process of S602, the CPU 29, upon judgment that the maintenance person is the full-time worker (YES in S602) or judgment that the authentication process using entry/exit permission information is successful (YES in S606), judges whether the completion signal transmitted from the terminal 5 is received (S607). The CPU 29, upon judgment that the completion signal is not received (NO in S607), perform the process of step S607 again.

The CPU 29, on the other hand, upon judgment that the completion signal received (YES in S607), performs a process of step S608.

Further explaining the process of step S606 and the process of step S607, the CPU 29, upon judgment that the authentication process using the entry/exit permission information fails (NO in S606) or judgment that the completion signal is received (YES in S607), transmits a deletion command of the entry/exit permission information to the communication terminal unit 5 of the maintenance person (S608). The CPU 29 stands by for a next request for performing. By performing this step S608, a malicious use of the entry/exit permission information temporarily afforded to the spot maintenance person is avoided.

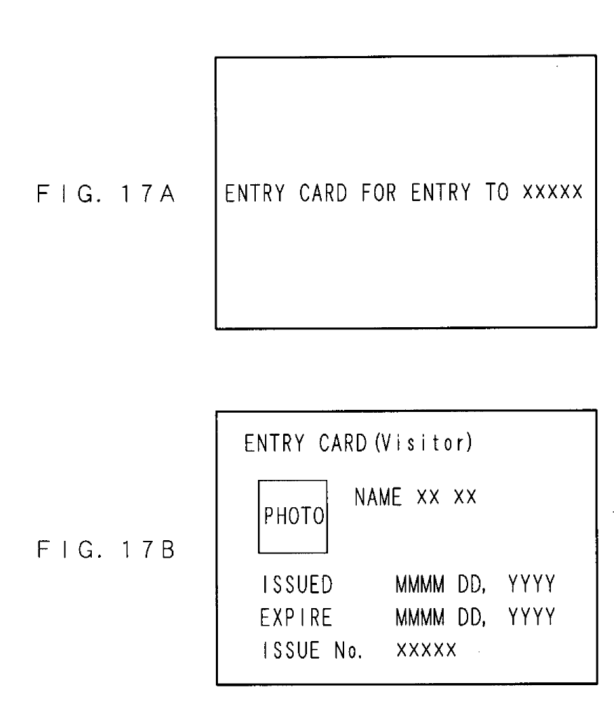

Now, the procedure for the generation process of the entry/exit permission information in step S603 is explained. In this embodiment, step S603 can includes generating the entry/exit permission information stationarily or generation the information dynamically, and both cases are explained below. FIG. 17A and Fig. B are exemplary schematic diagrams exemplarily representing entry/exit permission information to be displayed.

### Example 1

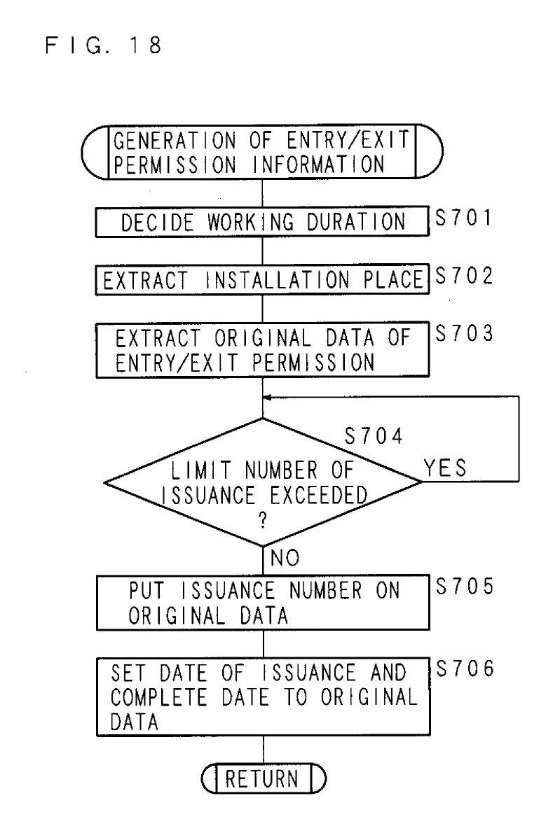

Procedure for a process for generating the entry/exit permission information stationarily is explained. FIG. 18 is a flowchart representing procedure for entry/exit permission information generation processes. The CPU 29 decides a working duration in accordance with a content of the fault (S701), referring to a fault listing table (not illustrated) stored in the auxiliary storage 25.

The CPU 29 extracts the device at fault from the fault information table T1 (S702). The CPU 29 extracts the installation place of the object device 1 corresponding to the identifier indicating the extracted device at fault from the device information table T5 (also, S702). The CPU 29 extracts the original data of entry/exit permission corresponding to the installation place thus extracted from the installation facility information table T6 (S703).

The CPU 29 extracts the limit number of issuance and the current number of issuance from the entry/exit permission management data T7 including the usage place corresponding to the extracted installation place. The CPU 29 judges whether the extracted current number of the issuance plus 1 exceeds the limit number of the issuance (S704). The CPU 29, upon judgment that the extracted current number of the issuance plus 1 exceeds the limit number of the issuance (YES in S704), performs step S704 again. The CPU 29 repeats the process until the current number of the issuance decreases by deletion of the entry/exit permission information.

The CPU 29, on the other hand, upon judgment that the extracted current number of the issuance plus 1 does not exceed the limit number of the issuance (NO in S704), puts a number as the issuance number on the original data of the entry/exit permission (S705). The CPU 29 sets the issuance date as a date of performing the process and sets the completion date as a date after the issuance date by the duration of service. The CPU 29 appends the issuance date and the completion date to the original data of the entry/exit permission to generate entry/exit permission data (S706). The CPU 29 converts the entry/exit permission data thus generated into image data in a text format as entry/exit permission information. The CPU 29 stands by until a next request for performing. The entry/exit permission information is outputted to the displaying part of the communication terminal unit 5, see, FIG. 17A.

### Example 2

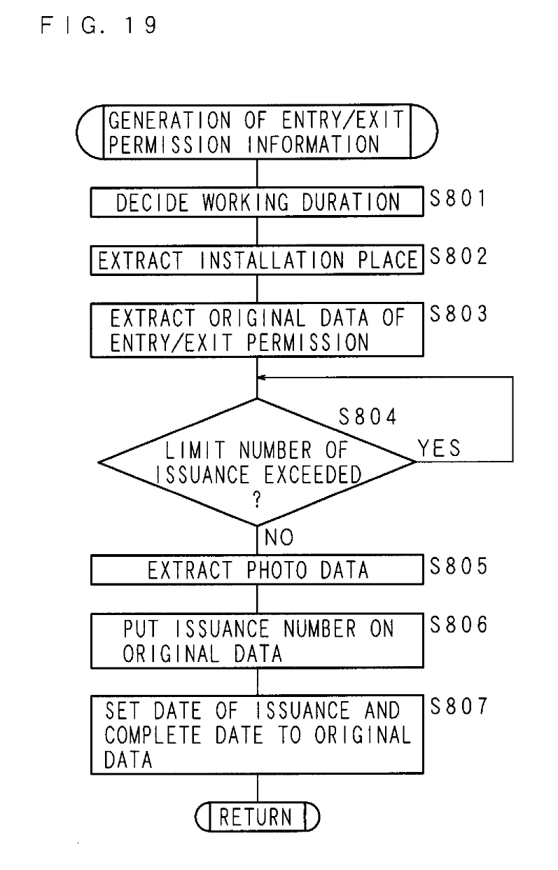

Procedure for a process for generating the entry/exit permission information dynamically is explained. FIG. 19 is a flowchart representing procedure for entry/exit permission information generation processes. The CPU 29 of the management device 2 decides a working duration in accordance with a content of the fault (S801), referring to a fault listing table (not illustrated) stored in the auxiliary storage 25.

The CPU 29 extracts the device at fault from the fault information table T1 (S802). The CPU 29 extracts the installation place of the object device 1 corresponding to the identifier indication the extracted device at fault from the device information table T5 (also, S802). The CPU 29 extracts the original data of entry/exit permission corresponding to the installation place thus extracted from the installation facility information table T6 (S803).

The CPU 29 extracts the limit number of issuance and the current number of issuance from the entry/exit permission management data T7 including the usage place corresponding to the extracted installation place. The CPU 29 judges whether the extracted current number of the issuance plus 1 exceeds the limit number of the issuance (S804). The CPU 29, upon judgment that the extracted current number of the issuance plus 1 exceeds the limit number of the issuance (YES in S804), performs step S804 again. The CPU 29 repeats the process until the current number of the issuance decreases by deletion of the entry/exit permission information.

The CPU 29, on the other hand, upon judgment that the extracted current number of the issuance plus 1 does not exceed the limit number of the issuance (NO in S804), extracts photo data of the maintenance person from the maintenance person information table T4 (S805). The CPU 29 puts a number as the issuance number on the original data of the entry/exit permission (S806). The CPU 29 sets the issuance date as a date of performing the process and sets the completion date as a date after the issuance date by the duration of service. The CPU 29 appends the issuance date and the completion date to the original data of the entry/exit permission to generate entry/exit permission data (S807). The CPU 29 converts the entry/exit permission data thus generated into image data along with the photo data as entry/exit permission information. The CPU 29 stands by until a next request for performing. The entry/exit permission information is outputted to the displaying part of the communication terminal unit 5, see, FIG. 17B.

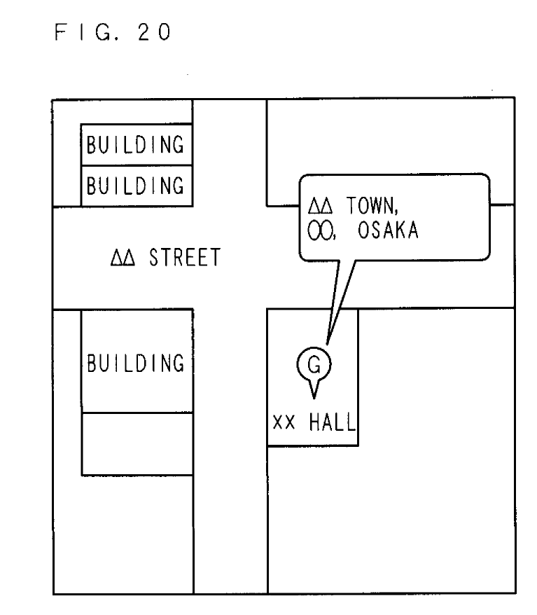

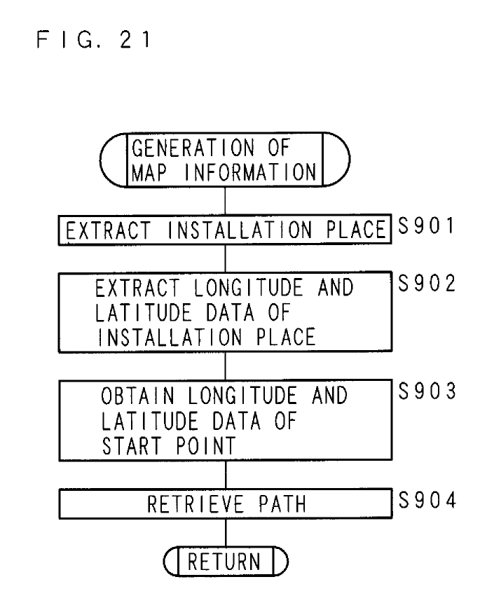

Now, the procedure for the generation process of the map information in step S604 is explained. FIG. 20 is an exemplary schematic diagram representative of displaying map information. FIG. 21 is a flowchart representing procedure for map information generation processes. The CPU 29 extracts the device at fault from the fault information table T1 (S901). The CPU 29 extracts the installation place of the object device 1 corresponding to the identifier indicating the extracted device at fault from the device information table T5 (also, S901). The CPU 29 extracts the longitude and latitude data of the installation place thus extracted from the installation facility information table T6 (S902).

The CPU 29 obtains longitude and latitude data of a start point based on an area where the maintenance person is in charge and a schedule of the maintenance (S903). The CPU 29 retrieves a path from the start point to the installation place, by matching both the longitude and latitude of the start point and the longitude and latitude of the installation place with map data obtained from a system of the outside (S904).

The CPU 29 superimposes marks indicating the start point and the installation place and the path from the start point to the installation place on the map data to generate map information. The CPU 29 stands by until a next process is requested. The map information is outputted to the displaying part of the communication terminal unit 5, see, FIG. 20.

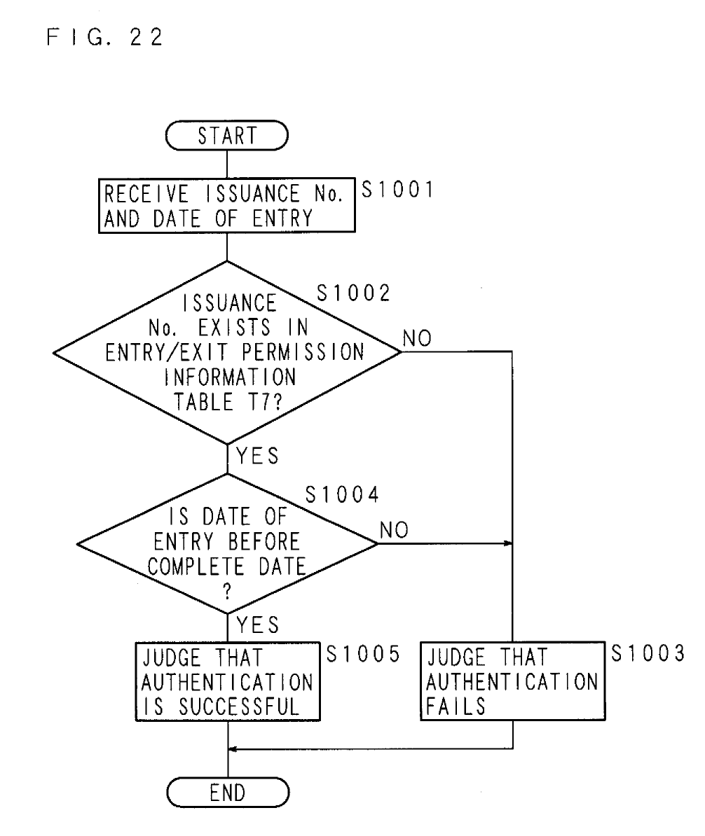

Now, the procedure for the authentication processes in step S606 is explained. FIG. 22 is a flowchart representing procedure for authentication processes using entry/exit permission information. The communication terminal unit 5 receives the above-mentioned entry/exit permission information and map information. The maintenance person holding the terminal 5 visits the installation facility of the object device 1 at fault, referring to the received map information. The maintenance person performs the authentication process to enter the installation facility using the entry/exit permission information.

The spot (part-time) maintenance person, for example, shows the entry/exit permission information outputted on the displaying part of the terminal 5 which is held by the person to a gate keeper of the installation facility. The gate keeper inputs the issuance number and a date of entry represented by the entry/exit permission information in a terminal of the gate keeper. The terminal of the gate keeper accepts and transmits the issuance number and the date of entry inputted by the gat keeper to the management device 2.

The CPU 29 of the management device 2 receives the issuance number and the date of entry transmitted by the terminal of the gate keeper (S1001). The CPU 29 judges whether the issuance number thus received exists in the entry/exit permission management data T7 (S1002). The CPU 29, upon judgment that the issuance number does not exist in the entry/exit permission management data T7 (NO in step S1002), judges that the authentication fails (S1003).

The CPU 29, on the other hand, upon judgment that the issuance number exists in the entry/exit permission information (YES in S1002), extracts the date of the issuance and the completion date corresponding to the issuance number from the entry/exit permission management data T7. The CPU 29 judges whether the date of the entry, which is received from the terminal of the gate keeper, is within a duration between the date of the issuance and the completion date (S1004). The CPU 29, upon judgment that the date of the entry is not within the duration (NO in S1004), judges that the authentication fails (S1003).

The CPU 29, on the other hand, upon judgment that the date of the entry, which is received from the terminal of the gate keeper, is within the duration between the date of the issuance and the completion date (YES in S1004), judges that the authentication is successful (S1005).

### Second Embodiment

The above-mentioned first embodiment discloses the trouble-shooting measure for the fault performed by one selected maintenance person exemplarily. The disclosure of the support management method and system and the information processing apparatus used therein is not limited to the embodiment. For example, a variant wherein another maintenance person is further selected upon request for an additional maintenance person by the one selected maintenance person is also possible and such embodiment is explained as the second embodiment hereinafter.

In the second embodiment, a structure of the support management system is similar to that in the first embodiment. Thus, corresponding elements included in the structure have the same reference numerals as in the first embodiment and such elements are not explained here in detail.

In the support management system in the second embodiment, the object device 1 analyzes the fault in itself to obtain the fault information, and transmits the fault information. The management device 2 receives the fault information transmitted from the object device. The management device 2 chooses at first one first maintenance person suitable for the trouble-shooting measure against the fault based on the predetermined rules and the fault information thus received. The management device 2 transmits the trouble-shooting measure instruction to the communication terminal unit 5 of the one first maintenance person in priority of those of other maintenance persons who also stand by.

The CPU 29 of the management device 2 in the second embodiment transmits the trouble-shooting measure instruction to the terminal 5 of the first maintenance person by performing the measure support management process explained in the first embodiment (refer to S109). The terminal 5 receives the measure instruction transmitted from the management device 2 and displays the received measure instruction on the displaying part. The terminal 5 accepts the response signal inputted by the first maintenance person in accordance with the measure instruction and transmits the accepted response signal to the management device 2.

When the first maintenance person decides that it is difficult for him/her to handle the situation solely, the first maintenance person requests an additional maintenance person among from the members of the group to which the first maintenance person belongs by using the communication terminal unit 5. The terminal 5 accepts the request for the additional maintenance person and the name of the group inputted by the first maintenance person. The terminal 5 transmits the request and the name of the group to the management device 2.

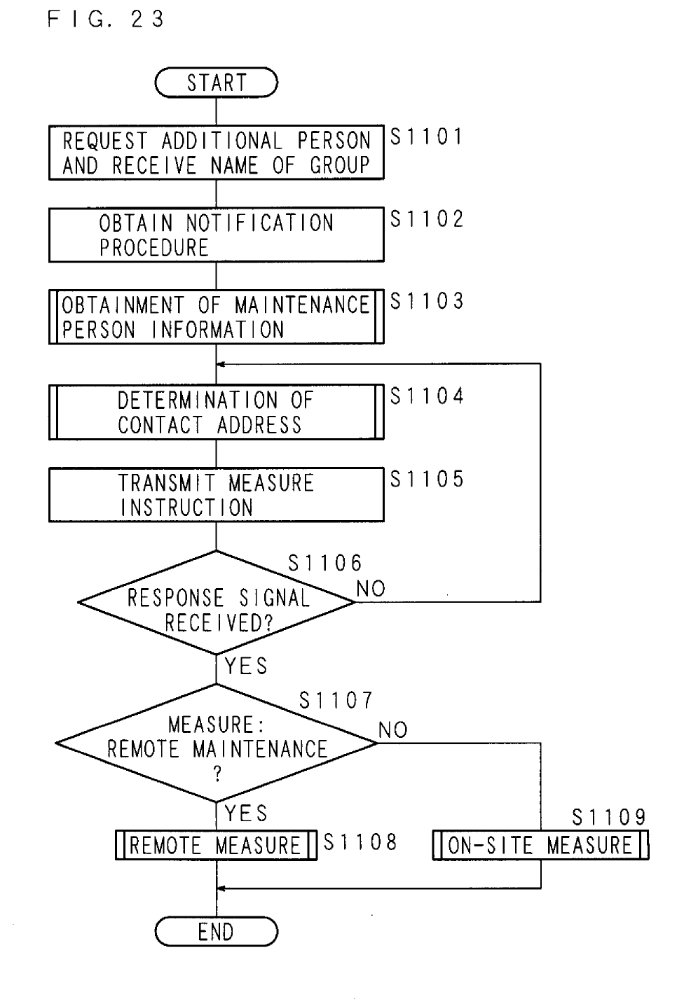

The CPU 29 of the management device 2, upon judgment that the response signal is received within the predetermined time period (refer to YES in S110) and judgment that the request and the name of the group are received, performs a maintenance person addition process, which is explained below, as well as performs the measure support management process of the above-mentioned first embodiment in parallel. FIG. 23 is a flowchart representing procedure for maintenance person addition processes.

The CPU 29 receives the request for the additional maintenance person and the name of the group transmitted from the communication terminal unit 5 of the first maintenance person (S101). The CPU 29 obtains a contact procedure corresponding to the accepted name of the group from the notification procedure list table T3 (S1102).

The CPU 29 performs the maintenance person obtainment process based on the obtained notification procedure (S1103). Procedure for the maintenance person information obtainment process is the same maintenance person information obtainment process as the first embodiment discloses (see, FIG. 13).

The CPU 29 performs the contact address determining process for determining the contact order to possible maintenance person to be added based on the obtained notification procedure and maintenance person information (S1104). Procedure for the contact address determining process is the same contact address determining process as the first embodiment discloses (see, FIG. 14). The CPU 29 transmits the measure instruction to the communication terminal unit 5 of the maintenance person who is in first priority to the others on the list except the first maintenance person (S1105). The terminal 5 of the maintenance person receives the measure instruction transmitted from the management device 2 and displays the received measure instruction on the displaying part. The terminal 5 accepts a response signal inputted by the maintenance person in accordance with the received measure instruction and transmits the accepted response signal to the management device 2.

The CPU 29 of the management device 2 judges whether the response signal is received from the communication terminal unit 5 within a predetermined time period (S1106). The CPU 29, upon judgment that the response signal is not received within the predetermined time period (NO in S1106), performs the process of step S1104. Further, when NO in S1106, the CPU 29 transmits the measure instruction to the maintenance person who is in the first priority to the others on the list except both the first maintenance person and the maintenance persons who have not inputted the response signal to the terminal 5 to transmit the response signal to the management device 2, referring to the contact order determined in the contact address determining process (see, FIG. 15).

The CPU 29, on the other hand, upon judgment that the response signal is received within the predetermined time period (YES in S1106), judges whether the trouble-shooting measure obtained from the trouble-shooting measure analyzing process (refer to step S102) is “remote maintenance” (S1107). The CPU 29, upon judgment that the measure is the “remote maintenance” (YES in S1107), perform the remote measure process with respect to the maintenance person to be added as second maintenance person (S1108), and terminates the maintenance person addition process. Procedure for the remote measure process is the same remote measure process as the first embodiment discloses (see, FIG. 16).

The CPU 29, on the other hand, upon judgment that the measure is not the “remote maintenance” (NO in S1107), performs the on-site measure process (S1109) and terminates the maintenance person addition process. Procedure for the on-site measure process is the same on-site measure process as the first embodiment discloses.

Thus, in the measure support system of the second embodiment, another (second) maintenance person in addition to the first maintenance person can perform the measure against the fault.

The embodiments described above represent a case in which, in the case where different maintenance persons are at the same qualification level in the notification procedure, for example, the maintenance person who has taken charge of the repair work a greater number of times is selected as an optimum maintenance person.

The invention, however, is not limited to such a case. As an alternative, the maintenance person may be selected in such a manner as to average out the number of times taken charge of by all the maintenance persons, for example, to prevent the instructions from being concentrated on a specified maintenance person.

According to an aspect of the aforementioned embodiment, an accurate and quick instruction can be issued to a maintenance person capable of dealing with a fault of an external device installed at a remote place without resorting to the human skill of the manager.

Also, the instruction can be issued dynamically to the most suitable maintenance person taking his/her job situation into consideration.

Also, according to an aspect of an embodiment, there is provided a support management system including a management device for supporting the trouble-shooting measure by receiving the fault information on the fault that has developed in an external device installed at a remote place and plural communication terminal units communicable with the management device, wherein the management device includes a unit acquiring the procedure for notification to the maintenance person based on the received fault information and a transmission unit transmitting a trouble-shooting instruction against the fault to the communication terminal unit of the maintenance person to be contacted in accordance with the acquired notification procedure, wherein the management device further includes an acquisition unit acquiring the job situation of each of plural maintenance persons, and a select unit selecting the optimum maintenance person based on the relation between the acquired notification procedure and the job situation, and wherein the transmission unit gives priority in the notification procedure to the transmission to the communication terminal unit of the maintenance person selected by the select unit.

According to an aspect of an embodiment, the notification procedure is acquired based on the fault information, and the trouble-shooting instruction against the fault is transmitted to the maintenance person in accordance with the acquired notification procedure, so that an instruction is issued accurately and quickly to the maintenance person capable of taking a trouble-shooting measure against the fault of the external device installed at a remote place without resorting to the human skill of the manager.

Further, the job situation of each of the plural maintenance persons is acquired and by taking the relation between the acquired notification procedure and the job situation into consideration, the transmission to the communication terminal unit of the selected maintenance person is given priority, so that the instruction is given dynamically to the most suitable maintenance person taking the job situation of the particular maintenance person into consideration.

Also, according to an aspect of an embodiment, the management device further includes a judging unit for judging whether the external device that has developed a fault can deal with the fault by itself or not, and upon judgment that the external device can deal with the fault by itself, the transmission unit performs no transmission to the communication terminal unit of the maintenance person.

According to an aspect of an embodiment, upon judgment that the external device that has developed a fault can deal with the fault by itself, no instruction is given to the maintenance person, and therefore, the useless transmission of the trouble-shooting instruction to the maintenance person is eliminated.

According to an aspect of an embodiment, the acquisition unit of the support management system acquires the job situation including the data indicating whether the maintenance person is at least in a position to confirm the trouble-shooting instruction, and the select unit deletes any maintenance persons not in a position to confirm the trouble-shooting instruction from the maintenance person select process.

According to an aspect of an embodiment, any maintenance person off duty or in vacation is determined as a maintenance person who cannot be contacted and deleted from the maintenance person select process, and the notification to other maintenance persons is considered, thereby making it possible to notify the maintenance persons positively.

According to an aspect of an embodiment, there is provided an information processing device including a unit receiving the fault information on a fault developed in an external device installed at a remote place, a unit acquiring the procedure for notification to a maintenance person based on the received fault information, an instruction transmission unit transmitting a trouble-shooting instruction against the fault to the communication terminal unit of the maintenance person to be contacted in accordance with the acquired notification procedure, a state acquisition unit acquiring the job situation of plural maintenance persons, and a maintenance person select unit selecting the optimum maintenance person based on the relation between the acquired notification procedure and the job situation, wherein the instruction transmission unit gives priority, in the acquired notification procedure, to the transmission to the communication terminal unit of the maintenance person selected by the maintenance person select unit.

According to an aspect of an embodiment, the notification procedure is acquired based on the fault information, and in accordance with the notification procedure thus acquired, a trouble-shooting instruction against the fault is transmitted to the maintenance person. Thus, the instruction can be issued accurately and quickly to the maintenance person capable of dealing with the fault of the external device installed at a remote place without resorting to the human skill of the manager.

Further, the job situation of each of plural maintenance persons is acquired, and the instruction is sent giving priority to the communication terminal unit of the maintenance person selected taking the relation between the acquired notification procedure and the job situation into consideration. As a result, the instruction is issued dynamically to the most suitable maintenance person taking the job situation of the maintenance person into consideration.

Furthermore, according to an aspect of an embodiment, the instruction by remote control operation is given in such a manner that the full-time maintenance person can execute the trouble-shooting measure as far as possible. Thus, the trouble-shooting measure against the fault can be positively carried out.

In the local trouble-shooting operation, on the other hand, an instruction is given to the maintenance person working in the neighborhood of the place of installation of the faulty external device to rush to the place of installation and take a trouble-shooting measure quickly against the fault.

Further, even a part-time maintenance person can take an appropriate measure by quickly moving to the place of installation with reference to the map information on the place of installation sent to him/her.

Also, in the local trouble-shooting operation, the entry/exit permit information for the place of installation of the faulty external device is transmitted to the maintenance person. Even in the case where the maintenance person is a part-time worker and holds no written entry/exit permission, therefore, the data effective as the entry/exit permission is immediately issued so that the maintenance person can rush to the place of installation to quickly take an appropriate measure against the fault.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of transmission communication media includes a carrier-wave signal.

Further, according to an aspect of the embodiments of the invention, any combinations of the described features, functions, operations, and/or benefits can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A support management method used with a management device for supporting a trouble-shooting measure against a fault in an external device, the support management method comprising:
receiving fault information on the fault that has occurred in the external device;
a installation place acquisition unit for acquiring an installation place of the external device in which the fault has occurred, on the basis of the receiving fault information;
a repair procedure acquisition unit for acquiring a repair procedure representing a list of candidates of qualified maintenance persons and an outline of the fault that can be dealt with by the maintenance persons included in the list, on the basis of a relation between the outline of the fault and the fault represented by the receiving fault information;
acquiring a job situation of the one or more qualified maintenance persons included in the list; and
transmitting in priority a trouble-shooting instruction against the fault to a communication terminal unit of an optimum qualified maintenance person selected based on a relation between the acquired installation place and the job situation of a maintenance person.

2. A support management computer system for supporting a trouble-shooting measure against a fault that has occurred in an external device installed at a remote place, the support management system comprising:
a computer processor executing a receiving unit for receiving fault information on the fault that has occurred in the external device;
a installation place acquisition unit for acquiring an installation place of the external device in which the fault has occurred, on the basis of the receiving fault information;
a repair procedure acquisition unit for acquiring a repair procedure representing a list of candidates of qualified maintenance persons and an outline of the fault that can be dealt with by the maintenance persons included in the list, on the basis of a relation between the outline of the fault and the fault represented by the receiving fault information;
a job situation acquisition unit for acquiring a job situation of the one or more qualified maintenance persons included in the list; and
a transmission unit for transmitting in priority a trouble-shooting instruction against the fault to a communication terminal unit of an optimum qualified maintenance person selected from the candidates of qualified maintenance persons based on a relation between the acquired installation place and the job situation of a maintenance person.

3. The support management computer system according to claim 2, wherein the computer processor further executes a self restoration judging unit for judging whether the fault indicated by the received fault information can be dealt with by the external device through a self restoration process,
wherein the transmission unit, upon judgment by the self restoration judging unit that the external device can troubleshoot through the self restoration process, does not perform the trouble-shooting instruction transmission.

4. The support management system according to claim 2,
wherein the job situation acquisition unit acquires the job situation including data indicating whether the maintenance person is in a position at least to confirm the trouble-shooting instruction, and
the transmission unit deletes the maintenance person not in a position to confirm the trouble-shooting instruction from the candidates of the qualified maintenance persons.

5. The support management system according to claim 2, wherein the computer processor further executes a trouble-shooting measure type specifying unit for selecting a remote trouble-shooting measure or a local trouble-shooting measure,
wherein upon designation of a remote trouble-shooting instruction by the trouble-shooting measure type specifying unit, the job situation acquisition unit acquires the job situation including data indicating whether the maintenance person is a full-time worker, and the transmission unit gives transmission priority to a communication terminal unit of the full-time maintenance person.

6. The support management system according to claim 5,
wherein upon designation of a local trouble-shooting instruction by the trouble-shooting measure type specifying unit, the acquisition unit acquires the job situation including data indicating whether the maintenance person is working in a neighborhood of a place of installation of the faulty external device, and
the transmission unit gives transmission priority to a communication terminal unit of a maintenance person working in the neighborhood of the place of installation of the faulty external device.

7. The support management system according to claim 6, wherein the transmission unit transmits, together with the trouble-shooting instruction, entry/exit permit information for permitting entry into/exit from the place of installation of the faulty external device and map information on the place of installation.

8. An information processing device comprising:
a computer readable recording medium; and
a computer processor executing
storing in the computer readable recording medium received fault information on a fault developed in an external device installed at a remote place;
acquiring an installation place of the external device in which the fault has occurred, on the basis of the receiving fault information;
acquiring a repair procedure representing a list of candidates of qualified maintenance persons and an outline of the fault that can be dealt with by the maintenance persons included in the list, on the basis of a relation between the outline of the fault and the fault represented by the receiving fault information;
acquiring a job situation of one or more maintenance person included in the list; and
selecting an optimum maintenance person from among the qualified maintenance persons based on a relation between the acquired installation place and the job situation of a maintenance person; and
transmitting a trouble-shooting instruction to a communication terminal unit of an optimum qualified maintenance person, according to the selecting.

9. The information processing device according to claim 8, wherein the computer processor further executes:
judging whether the external device that has developed a fault can deal with the fault, and
not transmitting an instruction to the communication terminal unit of the maintenance person when judged that the external device can deal with the fault.

10. The information processing device according to claim 8, wherein the acquiring acquires the job situation including data indicating at least whether the maintenance person is in a position to confirm the trouble-shooting instruction, and the selecting deletes the maintenance person not in a position to confirm the trouble-shooting instruction from the selection process.

11. The information processing device according to claim 8, wherein the computer processor further executes selecting a remote trouble-shooting measure or a local trouble-shooting measure,
wherein upon designation of a remote trouble-shooting measure, the acquiring acquires the job situation including data indicating whether the maintenance person is a full-time worker, and the selecting selects in priority the full-time maintenance person as the optimum qualified maintenance person.

12. The information processing device according to claim 11, wherein upon designation of a local trouble-shooting measure, the acquiring acquires the job situation including data indicating whether the maintenance person is working in a neighborhood of a place of installation of the faulty external device, and the selecting selects in priority the maintenance person working in the neighborhood of the place of installation of the faulty external device as the optimum qualified maintenance person.

13. The information processing device according to claim 12, wherein the transmitting transmits, together with the trouble-shooting instruction, entry/exit permit information for the place of installation of the faulty external device and map information on the place of installation.
